(19) United States
(12) Patent Application Publication
(10) Pub. No.: US 2026/0054318 A1
(43) Pub. Date: Feb. 26, 2026

(54) INTEGRATED MODULE FOR FORMING, DRESSING AND CHANGING, AND APPARATUS

(71) Applicant: GUANGZHOU MINO EQUIPMENT CO., LTD., Guangzhou (CN)

(72) Inventors: Bangchao QIU, Guangzhou (CN); Weibing YAO, Guangzhou (CN); Ting ZHANG, Guangzhou (CN); Peizhong LI, Guangzhou (CN); Jiaxin WANG, Guangzhou (CN); Guanzhong DENG, Guangzhou (CN)

(73) Assignee: GUANGZHOU MINO EQUIPMENT CO., LTD., Guangzhou (CN)

(21) Appl. No.: 19/375,982

(22) Filed: Oct. 31, 2025

Related U.S. Application Data
(63) Continuation of application No. PCT/CN2024/107639, filed on Jul. 25, 2024.

(30) Foreign Application Priority Data
Dec. 29, 2023 (CN) 202323648322.0

(51) Int. Cl. B23K 9/26; B23P 19/04; B23P 21/00

(52) U.S. Cl. CPC B23K 9/26; B23P 19/04; B23P 21/008

(57) ABSTRACT

An integrated module for forming, dressing and changing and an apparatus includes a primary mechanism, a forming mechanism, a dressing mechanism and a changing mechanism. The primary mechanism includes a mounting surface. The forming mechanism is configured to squeeze an electrode cap. The dressing mechanism is configured to cut the electrode cap. The changing mechanism is configured to remove or install the electrode cap. The forming mechanism, the dressing mechanism, and the changing mechanism are all provided on the mounting surface and are arranged at intervals from each other. According to the present application, the forming mechanism, the dressing mechanism and the changing mechanism are integrated on the mounting surface of the primary mechanism, thereby facilitating automatic switching between the dressing and forming functions, and thus the time required for manual operation and space occupation are greatly reduced.

### CROSS-REFERENCE TO RELATED APPLICATIONS

This application is a continuation of International Application No. PCT/CN2024/107639, filed on Jul. 25, 2024, which claims priority to Chinese Patent Application No. 202323648322.0, filed on Dec. 29, 2023. The disclosures of the aforementioned applications are hereby incorporated by reference in their entireties.

### TECHNICAL FIELD

The present application relates to the field of resistance welding technologies, and in particular to an integrated module for forming, dressing, and changing and a device.

### BACKGROUND

In an automotive welding production line, as the number of spot welding operations increase, an electrode cap used for welding will be damaged, so it is necessary to grind or shape the electrode cap. When an outer wall thickness of the electrode cap after dressing is less than a specified allowable thickness, the electrode cap needs to be replaced by a new electrode cap.

In related technologies, the dressing, forming, and changing of the electrode cap are essentially three different processes. If it is necessary to switch between dressing and forming functions, tools need to be manually replaced. Therefore, if it is necessary to alternately process the electrode cap with dressing and forming, it is required to manually replace the tools or add a device to reduce manual operation.

However, these methods will greatly increase maintenance costs and an occupied area of a site, and thereby affecting the operation of welding production line and being not conducive to achieving a high level of automation.

### SUMMARY

In view of this, it is necessary to provide an integrated module for forming, dressing, and changing and apparatus to solve the problem that the above-mentioned methods for processing the electrode cap increases maintenance costs and an occupied area of a site.

In a first aspect, the present application provides an integrated module for forming, dressing, and changing, which adopts the following technical solution.

An integrated module for forming, dressing and changing includes a primary mechanism, a forming mechanism, a dressing mechanism, and a changing mechanism. The primary mechanism includes a mounting surface. The forming mechanism is configured to squeeze an electrode cap. The dressing mechanism is configured to cut the electrode cap. The changing mechanism is configured to remove or install the electrode cap. The forming mechanism, the dressing mechanism, and the changing mechanism are all provided on the mounting surface and are arranged at intervals from each other.

By adopting the above technical solution, the forming mechanism, the dressing mechanism, and the changing mechanism are all integrated on the mounting surface of the primary mechanism, so that the module simultaneously have three functions: forming, dressing and changing, thereby facilitating automatic switching between the dressing and forming functions, and thus the time required for manual operation and space occupation are greatly reduced.

In an embodiment, the changing mechanism includes a removal assembly installed on the primary mechanism, and the removal assembly is configured to remove the electrode cap.

By adopting the above technical solution, the removal assembly in the removal mechanism is used for removing the electrode cap, so that a discarded electrode cap is removed and manual intervention is reduced.

In an embodiment, the changing mechanism also includes at least one cap storage assembly, the at least one cap storage assembly is configured to store the electrode cap, and each cap storage assembly is detachably installed on the primary mechanism.

By adopting the above technical solution, when it is necessary to replace electrode cap of different models, an operator may replace the cap storage assemblies storing electrode cap of different sizes according to actual requirements to achieve rapid replacement of the different model electrode caps, and thus an operational efficiency is improved.

In an embodiment, the primary mechanism includes a driving component and a transmission assembly, and the transmission assembly is in transmission connection between the driving component and any one of the forming mechanism, the dressing mechanism and the changing mechanism to drive the forming mechanism, the dressing mechanism and the changing mechanism to operate.

By adopting the above technical solution, the driving component is in transmission connection with any one of the forming mechanism, the dressing mechanism, and the changing mechanism through the transmission assembly, so that the driving of the forming mechanism, the dressing mechanism and the changing mechanism is realized, and thus the driving force for the operation of the forming mechanism, the dressing mechanism, and the changing mechanism is transmitted.

In an embodiment, the primary mechanism also includes a mounting base, the mounting base includes the mounting surface, the mounting base has a cavity inside, the transmission assembly is provided in the cavity, and the driving component is installed on the mounting base.

By adopting the above technical solution, the mounting base provides an installation base for the forming mechanism, the dressing mechanism, the changing mechanism and the driving component, enabling the forming mechanism, the dressing mechanism, the changing mechanism and the driving component to be integrally installed on the same component, and thus an integration of the overall module is improved. In addition, the installation cavity is provided in the mounting base to accommodate the transmission assembly, so that the transmission assembly is protected, thereby the transmission assembly is not easily to be blocked by debris generated during dressing and other external impurities during operation, and thus a smooth operation of the transmission assembly is realized.

In an embodiment, the changing mechanism also includes two damping assemblies, the two damping assemblies are symmetrically provided on two sides of the mounting surface, and are connected to the removal assembly to apply a damping force to the removal assembly.

By adopting the above technical solution, the two damping assemblies are symmetrically provided on two sides of the removal assembly to apply a damping force to the removal assembly, so that ensuring that a clamping jaw of the removal assembly does not rotate with the electrode cap when removing the electrode cap, and thus a normal operation of the clamping jaw is ensured.

In an embodiment, the primary mechanism also includes a mounting base, the damping assembly includes a shaft sleeve component, a damping member and an elastic member, the shaft sleeve component is installed on the mounting base, the damping member is installed on the shaft sleeve component, and the elastic member is clamped between the shaft sleeve component and the damping member.

By adopting the above technical solution, the shaft sleeve component and the damping member work together to increase damping effect, and thus allowing the clamping jaw of the cap removal assembly to extend or retract smoothly.

In a second aspect, the present application provides an apparatus adopting the following technical solution.

An apparatus includes a supporting frame mechanism and the integrated module for forming, dressing and changing mentioned above. The supporting frame mechanism includes a base and a supporting frame connected to the base. The integrated module for forming, dressing and changing is connected to the supporting frame.

By adopting the above technical solution, the base is configured to install on the ground as a basic component, the supporting frame is connected to the base for installing the integrated module for forming, dressing and changing. The supporting frame mechanism provides a support force for the integrated module for forming, dressing and changing, thereby allowing the integrated module for forming, dressing and changing to be placed at a specific position for processing an electrode cap, and thus facilitating unified planning and management within a factory premises.

In an embodiment, the apparatus also includes a floating mechanism. The floating mechanism is connected between the integrated module for forming, dressing and changing and the supporting frame mechanism. The floating mechanism is configured to be capable of extending and retracting along a first direction, and the first direction being perpendicular to the mounting surface.

By adopting the above technical solution, the floating mechanism is able to extend and retract along the first direction to provide a cushioning effect, so that vibration caused by a welding gun on the integrated module for forming, dressing and changing during removing, forming and dressing the electrode cap is reduced. At the same time, by providing the floating mechanism, the integrated module for forming, dressing and changing, which has experienced displacement in the first direction, is also able to be reset to a preset position, so that a possibility of collision due to a position deviation of the integrated module for forming, dressing and changing in the first direction when an electrode rod of the welding gun moves is reduced.

In an embodiment, the apparatus also includes a lifting adjustment mechanism. The lifting adjustment mechanism is connected between the floating mechanism and the supporting frame, and the floating mechanism is capable of moving along the first direction with assistance of the lifting adjustment mechanism.

By adopting the above technical solution, before performing a processing operation, the floating mechanism is able to move along the first direction with the assistance of the lifting adjustment mechanism according to actual requirements of an operator to adjust a position (for example height) of the integrated module for forming, dressing and changing in the first direction, so that the integrated module for forming, dressing and changing is able to be adapted to the operator's height.

In an embodiment, the apparatus also includes a collection mechanism, the collection mechanism includes a collection box and a collection tube, the collection box is installed on the supporting frame, and the collection tube is connected between the changing mechanism and/or the dressing mechanism and the collection box to collect the removed electrode cap or debris generated during a dressing process.

By adopting the above technical solution, wastes generated during a processing will be collected by the collection mechanism 9, so that accumulation of the removed electrode caps and the debris generated by dressing on an operating surface which affects subsequent processing is reduced. At the same time, by collecting the removed electrode caps and the debris generated by dressing, pollution to the operating environment is also effectively reduced.

In an embodiment, the apparatus also includes a power supply mechanism. The power supply mechanism is electrically connected to the primary mechanism, and the power supply mechanism is configured to supply energy to the primary mechanism.

By adopting the above technical solution, the power supply mechanism is configured to supply electrical energy to the primary mechanism to drive the driving component to operate, and thereby driving the forming mechanism, the dressing mechanism and the changing mechanism to operate.

According to the integrated module for forming, dressing and changing mentioned above, by integrating the forming mechanism, the dressing mechanism and the changing mechanism on the mounting surface of the primary mechanism, so that this module simultaneously have the three functions of forming, dressing and changing, thereby facilitating the automatic switching between the dressing and forming functions, and thus the time required for manual operation and space occupancy are greatly reduced.

### BRIEF DESCRIPTION OF THE DRAWINGS

FIG. 1 is a three-dimensional view of an integrated module for forming, dressing and changing and a floating mechanism according to an embodiment of the present application.

FIG. 2 is an exploded view of an integrated module for forming, dressing and changing according to an embodiment of the present application.

FIG. 3 is a schematic diagram of an overall structure of an apparatus according to an embodiment of the present application.

FIG. 4 is a schematic diagram of the integrated module for forming, dressing and changing, the floating mechanism, and a lifting adjustment mechanism according to an embodiment of the present application.

### DETAILED DESCRIPTION OF THE EMBODIMENTS

In order to make the above objectives, features, and advantages of the present application more obvious and easier to understand, the specific embodiments of the present application will be described in detail below with reference to the drawings. In the following description, many specific details are set forth in order to provide a thorough understanding of the present application. However, the present application can be implemented in many other ways different from those described herein. Those skilled in the art can make similar improvements without departing from the connotation of the present application. Therefore, the present application is not limited by the specific embodiments disclosed below.

In the description of the present application, it should be understood that, if there are terms such as “center”, “longitudinal”, “transverse”, “length”, “width” “thickness”, “upper”, “lower”, “front”, “rear”, “left”, “right”, “vertical”, “horizontal”, “top”, “bottom”, “inner”, “outer”, “clockwise”, “counterclockwise”, “axial” “radial” and “circumferential”, an orientation or positional relationship indicated by these terms is based on the orientation or positional relationship shown in the drawings, which is merely for the convenience of describing the present application and simplifying the description, and does not intend to indicate or imply that the device or element referred to must have a specific orientation or be constructed and operated in a specific orientation. Therefore, it should not be understood as a limitation on the present application.

In addition, if there are terms such as “first” and “second” appear, these terms are merely used for descriptive purposes, and cannot be understood as indicating or implying relative importance or implicitly indicating the number of technical features referred to. Consequently, features defined with “first”, “second” may explicitly or implicitly include at least one of the features. In the description of the present application, if there is a term “plurality”, the meaning of “plurality”is at least two, such as two, three, unless explicitly and specifically defined otherwise.

In the present application, unless explicitly specified and defined otherwise, if there are terms such as “install”, “communicate”, “connect”, “fix” appear, these terms should be understood broadly. For example, it may be a fixed connection, a detachable connection, or an integral connection; it may be a mechanical connection or an electrical connection; it may be a direct connection or an indirect connection through an intermediate medium; or it may be internal communication of two elements or an interaction relationship between two elements, unless explicitly defined otherwise. For those of ordinary skill in the art, the specific meanings of the above terms in the present application may be understood according to specific situations.

In the present application, unless explicitly specified and defined otherwise, if there is description that a first feature is “on” or “under” a second feature and the like, it may mean that the first feature and the second feature are in direct contact, or the first feature and the second feature are in indirect contact through an intermediate medium. Moreover, a first feature “above”, “over” and “on” a second feature may mean that the first feature is directly above or obliquely above the second feature, or it may simply mean that a horizontal height of the first feature is higher than a horizontal height of the second feature. A first feature “below”, “under”, and “beneath” a second feature may mean that the first feature is directly below or obliquely below the second feature, or it may simply mean that a horizontal height of the first feature is less than a horizontal height of the second feature.

It should be noted that, if an element is referred to as ‘fixed to’ or ‘set on’ another element, it may be directly fixed or set on the other element or there may be an intermediate element. If an element is considered to be “connected” to another element, it may be directly connected to the other element or there may be an intermediate element at the same time. If they exist, the terms “vertical”, “horizontal”, “upper”, “lower”, “left”, “right”, and similar expressions used in the present application are merely for illustrative purposes, and do not represent the merely implementation. “The first direction” may be a vertical direction, and the first direction is perpendicular to the mounting surface; and “the second direction”may be a horizontal direction.

Under the fierce competition of modern automotive industry, each automaker has higher requirements for an efficiency of automotive production, and a highly automated automotive production line is a key factor in increasing output. In an automotive welding production line, as the number of spot welding operations increase, an electrode cap used for welding will be damaged. Therefore, so it is often necessary to grind or shape the electrode cap. When an outer wall thickness of the electrode cap after dressing is less than a specified allowable thickness, the electrode cap needs to be replaced by a new electrode cap.

Currently, existing apparatuses at most merely have two functions: either dressing and changing or forming and changing, and all three functions, forming, dressing and changing, cannot be integrated into one apparatus. If switching between dressing and forming functions is required, tools need to be manually replaced. If both dressing and forming needs to be alternately performed on the electrode cap, it is necessary to manually replace the tools continuously or add an apparatus to reduce manual operation. These manners will greatly increase maintenance costs and an occupied area of a site, and thereby affecting the operation of welding production line and being not conducive to achieving a high level of automation.

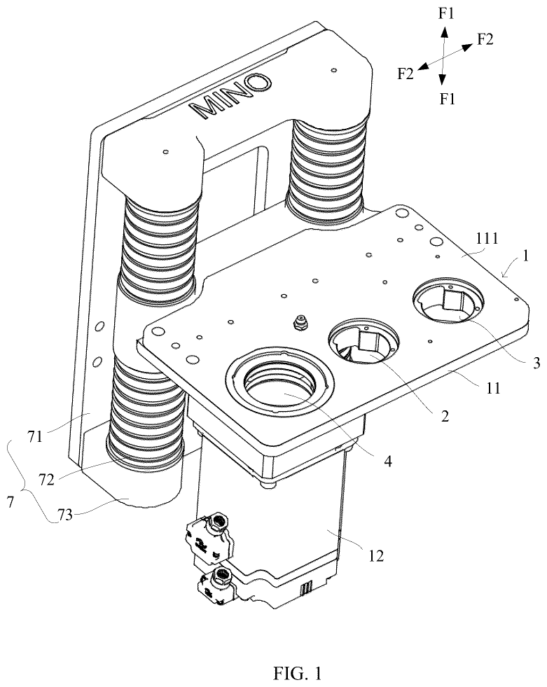

Further detailed description of the embodiments of the present application is provided below with reference to FIG. 1 to FIG. 4.

Referring to FIG. 1, which shows a three-dimensional view of an integrated module for forming, dressing and changing and a floating mechanism 7 according to an embodiment of the present application. An embodiment of the present application provides an integrated module for forming, dressing and changing, which includes a primary mechanism 1, a forming mechanism 2, a dressing mechanism 3 and a changing mechanism 4. The forming mechanism 2, the dressing mechanism 3 and the changing mechanism 4 are all installed on the primary mechanism 1 and are arranged at intervals from each other. Therefore, an integrated design of the forming mechanism 2, the dressing mechanism 3 and the changing mechanism 4 is achieved, so that the module simultaneously has forming, dressing and changing functions, thereby achieving automatic switching between the dressing, forming, and changing functions, and thus the time required for manual operation and space occupation is reduced.

The primary mechanism 1 is configured to provide installation positions for the forming mechanism 2, the dressing mechanism 3 and the changing mechanism 4. The forming mechanism 2 is configured to squeeze an electrode cap to shape the electrode cap. The dressing mechanism 3 is configured to cut the electrode cap to grind a surface of the electrode cap. The changing mechanism 4 is configured to remove or install the electrode cap.

Specifically, the primary mechanism 1 includes a mounting surface 111. In the embodiment of the present application, the mounting surface 111 is specifically an end surface of the primary mechanism 1 on a side facing toward an operator in a first direction F1. The forming mechanism 2, the dressing mechanism 3 and the changing mechanism 4 above-mentioned are all installed on the mounting surface 111 and are arranged at intervals from each other. In the embodiment of the present application, to facilitate a changing operation, the changing mechanism 4 is provided at an edge of the mounting surface 111, and the forming mechanism 2 is provided between the changing mechanism 4 and the dressing mechanism 3.

Both the changing mechanism 4 and the dressing mechanism 3 required to be connected to a collection mechanism 9 described below to collect the electrode caps removed by the changing mechanism 4 and the debris produced by the dressing mechanism 3. Since the motor needs to be connected to a transmission assembly 13 disposed in an installation seat 11 described below, the motor is generally disposed under the middle-rear section of the installation seat 11. By disposing the changing mechanism 4 and the dressing mechanism 3 at two sides of the front end of the installation seat 11, on one hand, it may avoid interference therebetween and reduce a size of the installation seat 11, thereby reducing an overall size of machine; on the other hand, they are close to a cap storage assembly 42 described below, thereby facilitating to enter the electrode cap installation process after the electrode cap removal process is completed.

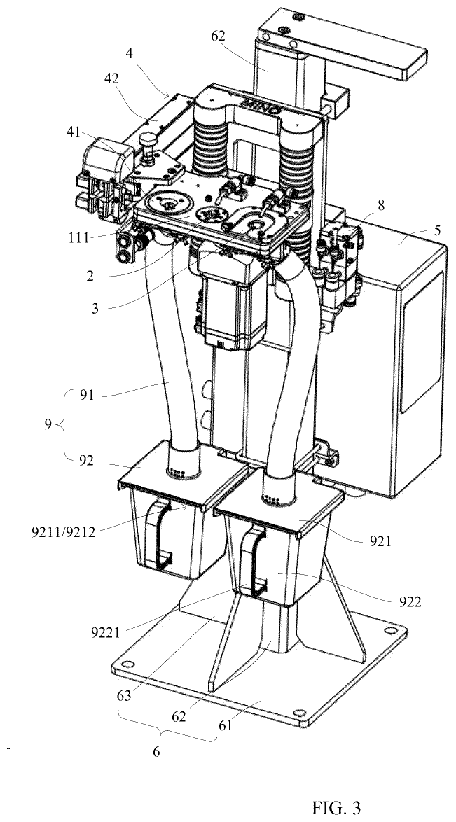

Continuing referring to FIG. 1 and FIG. 3, the changing mechanism 4 includes a removal assembly 41 and at least one cap storage assembly 42. Each cap storage assembly 42 stores an electrode cap with a size different from an electrode cap stored in another cap storage assembly 42. Before a processing operation, an operator may select a corresponding cap storage assembly 42 according to actual changing requirements. The removal assembly 41 is installed on the aforementioned primary mechanism 1, and any cap storage assembly 42 is able to be connected to the primary mechanism 1 to provide a new electrode cap for the changing operation.

Further, in the present embodiment, the cap storage assembly 42 and the primary mechanism 1 are connected by a quick-release method, enabling quick replacement between the cap storage assemblies 42 storing the electrode caps with different sizes, thereby reducing the time spent on adjusting operations of forming, dressing and changing of the electrode cap, and thus improving the convenience of using the module. Specifically, the quick-release structure may be a riveting or a plug-in structure.

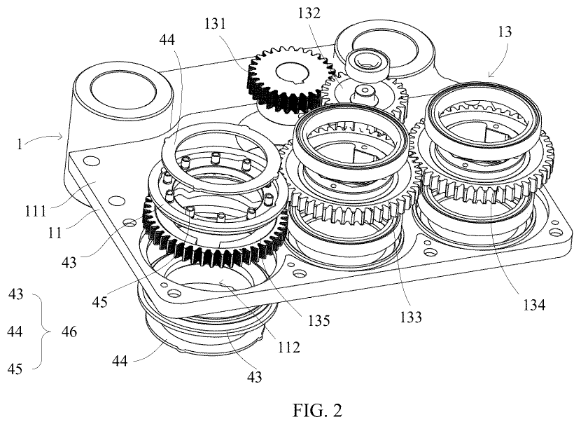

Referring to FIG. 1 and FIG. 2, FIG. 2 shows an exploded view of the integrated mounting for forming, dressing and changing according to an embodiment of the present application. In the embodiment 1, the primary mechanism 1 also includes a mounting base 11, a driving component 12, and a transmission assembly 13. In the embodiment of the present application, the mounting base 11 is specifically a box cover, and the box cover has the aforementioned mounting surface 111. The mounting base 11 is provided with a cavity 112 inside for accommodating the transmission assembly 13 to achieve the accommodation of the transmission assembly 13. The driving component 12 is installed on a side of the mounting base 11 facing away from the mounting surface 111. The transmission assembly 13 is in transmission connection between the driving component 12 and the forming mechanism 2, the dressing mechanism 3, and the changing mechanism 4 aforementioned to drive the forming mechanism 2, the dressing mechanism 3, and the changing mechanism 4 to operate synchronously.

In the embodiment, the transmission assembly 13 is specifically a gear transmission structure. The transmission assembly 13 includes a driving gear 131, an idler gear132, and a plurality of transmission gears. The multiple transmission gears are respectively set in one-to-one correspondence with the forming mechanism 2, the dressing mechanism 3 and the changing mechanism 4 aforementioned. In the embodiments of the present application, the transmission gears include a forming gear 133 corresponding to the forming mechanism 2, a dressing gear 134 corresponding to the dressing mechanism 3, and a removal gear 135 corresponding to the changing mechanism 4.

Continuing to refer to FIG. 2, specifically, the driving component 12 may be a drive motor used for providing a driving force. The driving component 12 is installed along the first direction F1 on the mounting base 11, so that a drive shaft of the drive motor penetrates through the mounting base 11 along the first direction F1, thereby enabling the driving gear 131 to be coaxially connected to the drive shaft of the driving component 12, and thus the installation of the driving gear 131 is completed.

Specifically, the driving gear 131 is a driving gear configured to provide the driving force, the idler gear1 32 is a driven gear meshing with the driving gear 131, and the idler gear 132 is rotatably installed on the mounting surface 111. Any one of the forming gear 133, the dressing gear 134, and the removal gear 135 aforementioned is able to mesh with the driving gear 131 through the idler gear 132.

Referring to FIG. 2, in the embodiments of the present application, the dressing gear 134, the forming gear 133, and the removal gear 135 are sequentially arranged along a second direction F2 and mesh with each other in pairs. The second direction F2 is perpendicular to the first direction F1 and is parallel to the aforementioned mounting surface 111.

In the embodiment, merely meshing transmission between the forming gear 133 and the driving gear 131 through the idler gear 132 is illustrated as an example. In an actual operation, the driving component 12 drives the driving gear 131 to rotate to drive the idler gear 132 meshing with the driving gear 131 to rotate, then the idler gear 132 drives the forming gear 133 to rotate, and thus the dressing gear 134 and the removal gear 135 meshing with the forming gear 133 are driven to rotate synchronously to drive the forming mechanism 2, the dressing mechanism 3 and the changing mechanism 4 to operate synchronously.

Referring to FIG. 2, in the embodiment, the changing mechanism 4 also includes two groups of damping assemblies 46 connected to the removal assembly 41, the two groups of damping assemblies 46 are symmetrically provided on two sides of the mounting surface 111 with the mounting surface 111 as an axis to apply a damping force to the removal assembly 41.

Specifically, the damping assembly 46 includes a shaft sleeve component 43, a damping member 44, and an elastic member 45. The shaft sleeve component 43 is installed on the aforementioned removal gear 135, and the damping member 44 is installed on the aforementioned shaft sleeve component 43. In the embodiments of the present application, the shaft sleeve component 43 is specifically a removal shaft sleeve, the damping member 44 is specifically a friction plate installed on the removal shaft sleeve, and the elastic member 45 may be a flexible rubber ring or spring which is capable of elastic deformation. The elastic member 45 is clamped between the removal shaft sleeve and the friction plate.

In the embodiments of the present application, during a removal process, the shaft sleeve component 43 and the damping member 44 work together to increase damping effect, thereby enabling a clamping jaw of the removal assembly 41 to extend and retract smoothly, and thus the operational smoothness of the removal assembly 41 is improved.

Referring to FIG. 3, FIG. 3 shows a schematic diagram of an overall structure of the device according to Embodiment 1 of the present application. The embodiments of the present application also provide an apparatus, this apparatus includes a supporting frame mechanism 6 and the aforementioned integrated module for forming, dressing and changing. Specifically, the supporting frame mechanism 6 includes a base 61 and a supporting frame 62 connected to the base 61, and the integrated module for forming, dressing and changing is installed on the supporting frame 62.

The base 61 is fixed to the ground to serve as a load-bearing component. The supporting frame 62 is connected along the first direction F1 to a top surface of the base 61 in the first direction F1, and the supporting frame 62 is connected to the primary mechanism 1 of the integrated module for forming, dressing and changing to install and support the integrated module for forming, dressing and changing.

Further, to enhance connection strength and stability between the base 61 and the supporting frame 62, the supporting frame mechanism 6 also includes a plurality of stiffening ribs 63 connected between the base 61 and the supporting frame 62. The stiffening rib 63 may be connected to the base 61 and the supporting frame 62 by welding.

In the embodiments of the present application, the stiffening rib 63 is constructed into a triangular structure, and all the stiffening ribs 63 are uniformly arranged along a circumference of the supporting frame 62. The stiffening ribs 63 fill a gap between the base 61 and the supporting frame 62 and provides support for both of them, so that the apparatus is not prone to shifting in the second direction F2.

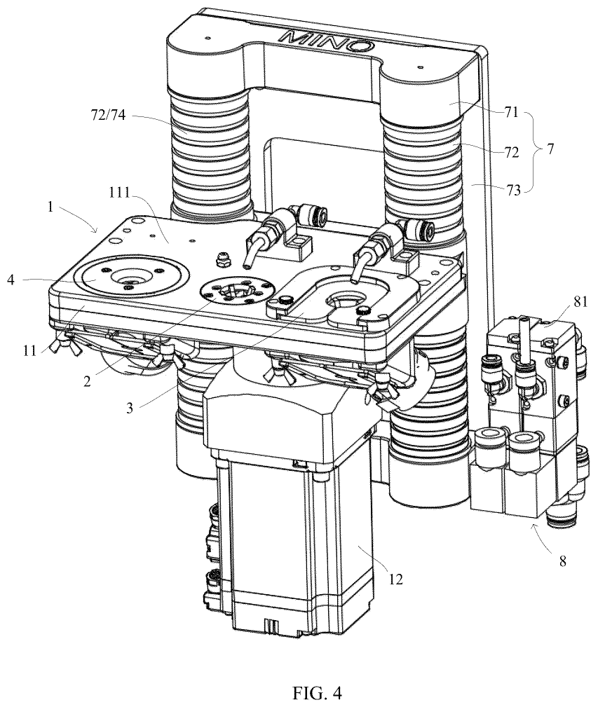

Referring to FIG. 1, FIG. 3 and FIG. 4, in the embodiments of the present application, the apparatus also includes a floating mechanism 7 installed between the supporting frame 62 and the integrated module for forming, dressing and changing. The floating mechanism 7 is connected to the aforementioned mounting base 11. In the embodiments of the present application, the floating mechanism 7 is configured to be able to extend and retract along the first direction F1 to provide a buffering effect to reduce vibration caused by a force applied by a welding gun to the mounting base 11 during removing, forming, and dressing the electrode cap.

In addition, by providing the floating mechanism 7, it also allows the mounting base 11 to quickly return to a preset position when it experiences displacement in the first direction F1, so that collision between an electrode rod of the welding gun and the mounting base 11 due to an offset of the mounting base 11 in the first direction F1 when the electrode rod of the welding gun moves, thereby the electrode rod is not prone to being damaged during use, and thus the operational safety of the device during processing is improved.

The floating mechanism 7 includes a fixed plate 71, at least two guide rods 74, and a pair of fixed bases 73. In the embodiments of the present application, merely an embodiment including the two guide rods 74 is shown. It may be understood that, in other embodiments, the guide rods 74 may also be three or more.

Specifically, the fixed plate 71 is connected to the aforementioned supporting frame 62, both the two guide rods 74 extend along the first direction F1, and the pair of fixed bases 73 are respectively connected to two opposite ends of the guide rods 74 in the first direction F1. The guide rods 74 are connected to the supporting frame 62 via the fixed base 73. The aforementioned mounting base 11 is slidably sleeved on the two guide rods 74, and an elastic component 72 is held between the mounting base 11 and the fixed base 73 (The elastic component 72 is sleeved over the guide rod 74). In the embodiment of the present application, the elastic member component 72 may be a spring or an elastic rubber ring that is able to undergo elastic deformation.

Referring to FIG. 4, which shows a schematic diagram of the integrated module for forming, dressing and changing, the floating mechanism 7, and a lifting adjustment mechanism 8 in embodiment 1 of the present application. In the embodiment 1, the device also includes a lifting adjustment mechanism 8 connected between the floating mechanism 7 and the supporting frame 62. Before performing a processing operation, according to actual requirement of an operator, the floating mechanism 7 is able to move along the first direction F1 via the lifting adjustment mechanism 8 to adjust a position (for example, a height) of the aforementioned integrated module for forming, dressing and changing in the first direction F1, so that the integrated module for forming, dressing and changing is adapted to the operator's height.

In the embodiment of the present application, the lifting adjustment mechanism 8 includes a clip 81 connected to the fixed plate 71, and an end of the clip 81 facing away from the fixed plate 71 is able to be adaptively clamped to the supporting frame 62 to achieve a detachable connection between the floating mechanism 7 and the supporting frame 62. Before performing a processing operation, firstly, a suitable clamping position is selected for the clip 81 according to a height and corresponding operational requirements of an operator, and then the clip 81 is locked to fix the position of the integrated module for forming, dressing and changing in the first direction F1 finally.

Continuing referring to FIG. 3, in the embodiment of the present application, the apparatus also includes a collection mechanism 9 for collecting wastes generated during processing. The wastes generated during processing will be collected by the collection mechanism 9 to reduce the pollution of the operating environment caused by the processing wastes.

Specifically, the collection mechanism 9 includes a collection tube 91 and a collection box 92. In the embodiment of the present application, there are two sets of the collection tube 91 and the collection box 92 separately, and the collection boxes 92 are all installed on the supporting frame 62. One of the collection tubes 91 is connected between the changing mechanism 4 and the corresponding collection box 92 to collect waste electrode caps that have been removed and replaced; and the other collection tube 91 is connected between the dressing mechanism 3 and the corresponding collection box 92, so that metal debris generated during the dressing process is able to fall along the collection tube 91 into the collection box 92 to be collected together, and thus the accumulation of the debris in the dressing mechanism 3 is reduced, which affects subsequent dressing operations.

In addition, to facilitate cleaning of the collected waste electrode caps and the debris for the operator, in the embodiment of the present application, the collection box 92 includes a fixing member 921 and a bearing member 922. The fixing member 921 is fixed on the supporting frame 62 by welding or bolt connection, and the fixing member 921 has an internal accommodating cavity 9211. The accommodating cavity 9211 penetrates through a side wall of the fixing member 921 to form an insertion port 9212, and the bearing member 922 is able to be inserted into the accommodating cavity 9211 through the insertion port 9212, so that the bearing member 922 is able to be movably installed in the fixing member 921.

In the embodiment of the present application, the fixing member 921 is specifically a housing with an internal accommodating cavity 9211, and the collection tube 91 is connected to an end of the housing. The bearing member 922 is specifically a drawer-like structure with an opening. After the bearing member 922 is installed in the accommodating cavity 9211, it is just able to receive the waste electrode cap or metal debris transported via the collection tube 91. The bearing member 922 may also be provided with a pulling handle 9221 to facilitate the removal of the bearing member 922 for cleaning the debris inside.

Referring to FIG. 3, in the embodiment of the present application, the apparatus also includes a power supply mechanism 5, the power supply mechanism 5 is installed on the supporting frame 62 and is electrically connected to the driving component 12 of the primary mechanism 1, the power supply mechanism 5 is configured to provide electrical energy to the driving component 12 to drive the driving component 12 to operate, and thereby driving the forming mechanism 2, the dressing mechanism 3 and the changing mechanism 4 to operate. In the embodiment of the present application, the power supply mechanism 5 is specifically an electrical box, and the power supply mechanism 5 is used for distributing electrical energy to make electrical circuit operations be more convenient.

In an alternative embodiment, the difference from the above embodiment lies in a different arrangement sequence of the forming mechanism 2, the dressing mechanism 3 and the changing mechanism 4 along the second direction F2 on the mounting base 11, and different meshing relationships between the driving gear 131 and the forming mechanism 2, the dressing mechanism 3, and the changing mechanism 4.

The structures that are the same or similar to the above embodiment will not be repeated herein, and the same features continue using the same reference numerals as in the embodiment 1.

In this embodiment, the dressing mechanism 3 may also be installed between the changing mechanism 4 and the forming mechanism 2. In addition, the changing mechanism 4 may also be installed between the forming mechanism 2 and the dressing mechanism 3.

It may be understood that, in this embodiment, based on the different arrangement sequence of the forming mechanism 2, the dressing mechanism 3 and the changing mechanism 4, along the second direction F2, the plurality of transmission gears may also be arranged in an sequence of the dressing gear 134, the removal gear 135 and the forming gear 133, or in an sequence of the forming gear 133, the dressing gear 134 and the removal gear 135. Similarly, the adjacent gears mesh with each other to achieve transmission.

In addition, compared to the above embodiment, in this embodiment, the driving gear 131 may mesh with the aforementioned dressing gear 134. During actual operation, the driving gear 131 drives the dressing gear 134 to rotate via the idler gear 132, and then drives the forming gear 133 and the removal gear 135 to rotate synchronously.

Alternatively, the driving gear 131 meshes with the aforementioned removal gear 135, and the driving gear 131 is in transmission connection with the removal gear 135 via the idler gear 132. When the driving gear 131 is driven by the driving component 12 to operate, the removal gear 135 is driven to rotate to drive the forming gear 133 and the dressing gear 134 to rotate synchronously, so that the forming mechanism 2, the dressing mechanism 3 and the changing mechanism 4 are driven to operate.

In another alternative embodiment, the lifting adjustment mechanism 8 includes a sliding block (not shown in the figures) connected to the fixed plate 71. The supporting frame 62 is provided with a sliding slot (not shown in the figures) on a side facing the fixed plate 71. The sliding slot extends along the first direction F1, and the sliding block is able to be slidably installed in the sliding slot and contacts a slot wall of the sliding slot.

The lifting adjustment mechanism 8 also includes a screw rotatably installed in the sliding slot. The screw penetrates through the sliding slot along the first direction F1 and is threadedly connected to the sliding block. The rotation of the screw drives the sliding block to reciprocate along the first direction F1, and thereby adjusting the position of the integrated module for forming, dressing and changing in the first direction F1.

Furthermore, a clearance hole (not shown in the figures) is provided at an end of the supporting frame 62 facing away from the base 61. The clearance hole is connected to the sliding slot along the first direction F1, and thereby allowing an end of the screw to extend out of the sliding slot through the clearance hole. In the embodiments of the present application, to facilitate the rotation of the screw, a driving handwheel (not shown in the figures) is also provided at the end of the screw extending out of the sliding slot. The driving handwheel is coaxially connected to the screw, thereby allowing an operator to rotate the screw by turning the driving handwheel, and thus the position of the integrated module for forming, dressing and changing is adjusted.

The technical features of the above-described embodiments may be combined in any way. For the sake of brevity, not all possible combinations of the technical features in the above embodiments are described. However, as long as there is no contradiction in the combination of these technical features, they should be considered within the scope of this specification.

The above-described embodiments only express several embodiments of the present application. The description is relatively specific and detailed, but it should not be understood as a limitation on the scope of the patent application. It should be noted that for those of ordinary skill in the art, without departing from the concept of the present application, several modifications and improvements can be made, all of which fall within the protection scope of the present application. Therefore, the protection scope of the present application should be determined by the appended claims.

What is claimed is:

1. An integrated module for forming, dressing and changing, comprising:
a primary mechanism, comprising a mounting surface;
a forming mechanism, configured to squeeze an electrode cap;
a dressing mechanism, configured to cut the electrode cap; and
a changing mechanism, configured to remove or install the electrode cap;
wherein, the forming mechanism, the dressing mechanism and the changing mechanism are all provided on the mounting surface and are arranged at intervals from each other.

2. The integrated module for forming, dressing and changing according to claim 1, wherein the changing mechanism comprises a removal assembly installed on the primary mechanism, and the removal assembly is configured to remove the electrode cap.

3. The integrated module for forming, dressing and changing according to claim 2, wherein the changing mechanism further comprises at least one cap storage assembly, the at least one cap storage assembly is configured to store the electrode cap, and each cap storage assembly is detachably installed on the primary mechanism.

4. The integrated module for forming, dressing and changing according to claim 1, wherein the primary mechanism comprises a driving component and a transmission assembly, and the transmission assembly is in transmission connection between the driving component and any one of the forming mechanism, the dressing mechanism and the changing mechanism to drive the forming mechanism, the dressing mechanism and the changing mechanism to operate.

5. The integrated module for forming, dressing and changing according to claim 4, wherein the primary mechanism further comprises a mounting base, the mounting base comprises the mounting surface, the mounting base has a cavity inside, the transmission assembly is provided in the cavity, and the driving component is installed on the mounting base.

6. The integrated module for forming, dressing and changing according to claim 2, wherein the changing mechanism further comprises two damping assemblies, the two damping assemblies are symmetrically provided on two sides of the mounting surface, and are connected to the removal assembly to apply a damping force to the removal assembly.

7. The integrated module for forming, dressing and changing according to claim 6, wherein the primary mechanism further comprises a mounting base, the damping assembly comprises a shaft sleeve component and a damping member, at least one of the two damping assemblies comprise an elastic member, the shaft sleeve component is installed on the mounting base, the damping member is installed on the shaft sleeve component, and the elastic member is clamped between the shaft sleeve component and the damping member in a case that the damping assembly comprises the elastic member.

8. The integrated module for forming, dressing and changing according to claim 1, wherein the changing mechanism is provided on an edge of the mounting surface, and the forming mechanism is provided between the changing mechanism and the dressing mechanism.

9. An apparatus, comprising:
a supporting frame mechanism, comprising a base and a supporting frame connected to the base; and
the integrated module for forming, dressing and changing according to claim 1, which is connected to the supporting frame.

10. The apparatus according to claim 9, further comprising a floating mechanism, wherein the floating mechanism is connected between the integrated module for forming, dressing and changing and the supporting frame mechanism, the floating mechanism is configured to be capable of extending and retracting along a first direction, and the first direction is perpendicular to the mounting surface.

11. The apparatus according to claim 10, further comprising a lifting adjustment mechanism, wherein the lifting adjustment mechanism is connected between the floating mechanism and the supporting frame, the floating mechanism is capable of moving along the first direction with assistance of the lifting adjustment mechanism, and the floating mechanism is connected to the mounting base.

12. The apparatus according to claim 11, wherein the floating mechanism comprises a fixed plate, at least two guide rods, and a pair of fixed bases, the fixed plate is connected to the supporting frame, the at least two guide rods extend along the first direction, the pair of fixed bases are respectively connected to two opposite ends of each guide rod in the first direction, and the mounting base is slidably sleeved over the at least two guide rods.

13. The apparatus according to claim 12, wherein the lifting adjustment mechanism comprises a clip connected to the fixed plate, and an end of the clip facing away from the fixed plate is clamped to the supporting frame to achieve a detachable connection between the floating mechanism and the supporting frame.

14. The apparatus according to claim 8, wherein the lifting adjustment mechanism is slidably connected to the supporting frame.

15. The apparatus according to claim 9, further comprising a collection mechanism, wherein the collection mechanism comprises a collection box and a collection tube, the collection box is installed on the supporting frame, and the collection tube is connected between the changing mechanism and/or the dressing mechanism and the collection box to collect the removed electrode cap or debris generated during a dressing process.

16. The apparatus according to claim 15, wherein the collection box further comprises a fixing member and a bearing member, the fixing member is fixed on the supporting frame, the fixing member has an accommodating cavity, the accommodating cavity has an insertion port, and the bearing member is inserted into the accommodating cavity through the insertion port to make the bearing member be movably installed in the fixing member.

17. The apparatus according to claim 16, wherein the bearing member is a drawer-like structure.

18. The apparatus according to claim 17, wherein the bearing member is provided with a pulling handle.

19. The apparatus according to claim 9, further comprising a power supply mechanism, wherein the power supply mechanism is electrically connected to the primary mechanism, and the power supply mechanism is configured to supply energy to the primary mechanism.

20. The apparatus according to claim 9, wherein the supporting frame mechanism further comprises a plurality of stiffening ribs connected between the base and the supporting frame.
